(19) United States
(12) Patent Application Publication
(10) Pub. No.: US 2016/0071511 A1
(43) Pub. Date: Mar. 10, 2016

(54) METHOD AND APPARATUS OF SMART TEXT READER FOR CONVERTING WEB PAGE THROUGH TEXT-TO-SPEECH

(71) Applicant: Samsung Electronics Co., Ltd., Suwon-si (KR)

(72) Inventors: An-na PARK, Suwon-si (KR); Byung-jun SON, Seoul (KR)

(21) Appl. No.: 14/846,331

(22) Filed: Sep. 4, 2015

(30) Foreign Application Priority Data
Sep. 5, 2014 (KR) 10-2014-0119361

(51) Int. Cl. G10L 13/08; G06F 17/27

(52) U.S. Cl. CPC G10L 13/08; G06F 17/2705; G06F 17/278; G10L 2013/083

(57) ABSTRACT

A method and an apparatus for outputting a full name voice of a unit or an abbreviation are provided. The method includes detecting a unit or an abbreviation from a text to be output as a voice, searching a full name database for the detected unit or abbreviation to acquire a full name of the detected unit or abbreviation, converting the acquired full name of the unit or abbreviation into a voice and outputting the voice. A context of a text content is parsed to be converted into a voice of an appropriate term so as to transmit accurate meaning information appropriate for a situation. This provides a huge help to a user and a visually handicapped person who has a low accessibility to a webpage. Also, a webpage and a mobile provide a smart talkback service for the accessibility of the visually handicapped person.

### CROSS-REFERENCE TO RELATED APPLICATION(S)

This application claims the benefit under 35 U.S.C. §119(a) of a Korean patent application filed on Sep. 5, 2014 in the Korean Intellectual Property Office and assigned Serial number 10-2014-0119361, the entire disclosure of which is hereby incorporated by reference.

### TECHNICAL FIELD

The present disclosure relates to methods and apparatuses for outputting a sound of a text. More particularly, the present disclosure relates to methods and apparatuses for outputting a full name sound of a word or an abbreviation included in a text.

### BACKGROUND

In order to convert information from a book, which includes scientific and math objects such as mathematical formulas, symbols, tables, figures, or pictures, into an audible voice, mathematical formula and symbol expressions are converted into different voice words through a knowledge acquisition medium, e.g., an Internet web, a mobile terminal, or the like.

A keyword of a meta tag, which expresses information existing in an Internet web page, e.g., letter, formula, symbol, table, figure, or picture information, as a voice, may be additionally used to check and search for information through incomplete index data of an existing web search engine.

An existing apparatus for converting a math object into a voice may use an optical character recognition that reads a letter form. Here, if an optical character recognition is used, it is difficult to distinguish parts that are necessary for the optical character recognition from parts that are unnecessary for the optical letter recognition. Also, only a letter having a fixed form may be misidentified.

Also, an existing method needs a mapping table database (DB) with which a server operates to convert information into a voice. This method needs a large amount of capacity and has a burden with a continuous access to the mapping table DB.

Also, the existing method does not have a guide to a selection criterion when several meanings of the unit or the abbreviation are detected. Therefore, the existing method is limited in a conversion of an ambiguous word into a voice knowledge.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide methods and apparatuses for outputting a full name voice of a unit or abbreviation that reads an abbreviation or a unit (e. g., information of a length, a weight, an area, a volume, a force, a pressure, a density, a temperature, a speed, a time, a viscosity, energy, a mathematical symbol, or the like) as a full name (or an original word) and synthesizing a text into a voice.

In accordance with an aspect of the present disclosure, a method of outputting a full name voice of a unit or an abbreviation is provided. The method includes detecting a unit or an abbreviation from text to be output as a voice, searching a full name database (DB) for the detected unit or abbreviation and acquiring a full name corresponding to the detected unit or abbreviation, and converting the acquired full name corresponding to the detected unit or abbreviation into a voice data and outputting a voice.

The detecting of the unit or abbreviation may include parsing the text into a character string having a meaning, and when the parsed character string is a preset arrangement pattern including at least one of a number, an alphabet, a symbol, a period, and capital and small letters, determining the parsed character string as a unit or an abbreviation.

If the character string is one of a “number+alphabet”, “number+non-alphabetic symbol”, “non-alphabetic symbol+number”, “/ between capital letters or small letters”, “combination of capital letters”, “capital letter+small letter+period”, “capital letter+period+capital letter+period”, and “symbol+number+alphabet”, determining that the character string is a unit or an abbreviation.

As another example, even if there is “symbol+number+alphabet”, the character string may be regarded as a unit or an abbreviation. Besides this, many more examples may occur.

The parsing of the text may include acquiring a hypertext mark-up language (HTML) page, extracting only text from the acquired HTML page by using an extensible mark-up language (XML) parser or a regular expression, and parsing the extracted text into the character string having the meaning.

If two full names are found in the search result of the full name DB, selecting one of the two found full names based on a context of the detected unit or abbreviation.

The selecting of one of the two found full names may include extracting keywords from the context, searching a related word DB, and selecting one of two or more full names based on the extracted keywords in view of the context and based on the search, wherein the related word DB is configured to rank search words and words used with the search word according to frequency of use.

The outputting of the voice may include, if the full name corresponding to the detected unit or abbreviation is acquired, converting the acquired full name into a voice data and outputting a voice.

The outputting of the voice may include if the full name corresponding to the detected unit or abbreviation is acquired, counting the number of words to be converted into voice data and if the number of words is greater than or equal to a preset number, converting the acquired full name into a voice data and outputting a voice.

In accordance with another aspect of the present disclosure, an apparatus for outputting a full name voice of a unit or an abbreviation is provided. The apparatus includes a processor configured to execute one or more programs, a memory configured to store a text-to-speech (TTS) program and a full name database (DB), and an audio output device configured to output an execution result of the TTS program as a voice, wherein the TTS program includes a command for detecting a unit or an abbreviation from a text to be output as a voice, a command for searching the full name DB for the detected unit or abbreviation to acquire a full name corresponding to the detected unit or abbreviation, and a command for converting the acquired full name corresponding to the unit or abbreviation into a voice data and outputting a voice.

The command for detecting the unit or abbreviation may include a command configured to parse the text into a character string having a meaning, and a command configured to, when the parsed character string having the meaning is formed in an arrangement pattern of a preset number, an alphabet, a symbol, a period, and capital and small letters, detect the parsed string having the meaning as the unit or the abbreviation.

If the parsed character string having the meaning is one selected from “number+alphabet”, “number+non-alphabetic symbol”, “non-alphabetic symbol+number”, “/ between capital letters or small letters”, “combination of capital letters”, “capital letter+small letter+period”, “capital letter+period+capital letter+period”, and “symbol+number+alphabet”, the character string is detected as the unit or the abbreviation.

As another example, even if there is “symbol+number+alphabet”, the character string may be regarded as a unit or an abbreviation. Besides this, many more examples may occur.

The command configured to parse the text information may include a command configured to bring an HTML page if a webpage is made with an HTML, a command configured to extract only text by using an XML parser or a result expression, and a command configured to parse the extracted text into the character string having the meaning.

The apparatus may further include a command configured to, if two full names are found in the search of the full name DB, select one of the two found full names based on a context of the detected unit or abbreviation.

The command configured to select one of the two found full names may include a command configured to extract keywords from the context, a command configured to search a related word DB, and a command configured to select a unit or an abbreviation having a meaning appropriate for a context by using the extracted keywords and the search result of the related word DB, wherein the related word DB is a DB configured to rank search words and words used with the search word according to frequency of use.

In accordance with another aspect of the present disclosure, an apparatus for outputting a full name voice of a unit or an abbreviation is provided. The apparatus includes a storage unit configured to store a TTS program and full name DB, a controller configured to execute the TTS program to cause the controller to detect a unit or an abbreviation from a text to be output as a voice, search the full name DB for the detected unit or abbreviation, acquire a full name of the detected unit or abbreviation, and convert the acquired full name corresponding to the unit or abbreviation into a voice data, and an audio output device configured to output the full name converted into the voice data as a voice.

The TTS program may further cause the controller to parse text information into a character string having a meaning, and when the parsed character string is a preset arrangement pattern including at least one of a number, an alphabet, a symbol, a period, and capital and small letters, and determine that the parsed character string is the unit or the abbreviation.

If the parsed character string having the meaning is one of “number+alphabet”, “number+non-alphabetic symbol”, “non-alphabetic symbol+number”, “/ between capital letters or small letters”, “combination of capital letters”, “capital letter+small letter+period”, “capital letter+period+capital letter+period”, and “symbol+number+alphabet”, the controller may determine that the character string is the unit or the abbreviation.

As another example, even if there is “symbol+number+alphabet”, the character string may be regarded as the unit or the abbreviation. Besides this, many more examples may occur.

If two full names are found based on the search of the full name DB, the controller may select one of the two full names based on a context.

The storage unit may store a related word DB configured to rank search words and words used with the search word according to frequency of use, wherein the TTS program may cause the controller to extract keywords from the context, search the related word DB, and select one of the searched full names based on the context by using the extracted keywords and the search result of the related word DB.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an apparatus for outputting a full name voice of a unit or an abbreviation according to an embodiment of the present disclosure;

FIG. 2 is a block diagram of an apparatus for outputting a full name voice of a unit or an abbreviation according to an embodiment of the present disclosure;

FIG. 3 is a flowchart of a method for outputting a full name voice of a unit or an abbreviation according to an embodiment of the present disclosure;

FIG. 4 is a flowchart of a method for outputting a full name voice of a unit or an abbreviation according to an embodiment of the present disclosure;

FIG. 5 is a flowchart of a method for detecting a unit or an abbreviation according to an embodiment of the present disclosure; and

FIGS. 6A, 6B, 6C, and 6D are views illustrating correlations between vocabularies appearing in meanings of the vocabularies and surrounding contexts according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Herein, a text is extracted from a part selected from a webpage, synthesized into a voice, and the voice is output. In this process, information of a unit (e.g., a length, a weight, an area, a volume, a force, a pressure, a density, a temperature, a speed, a time, a viscosity, energy, a mathematical symbol, an abbreviation, etc.) may be read as an expression appropriate for a corresponding full name (or an original word) in a web browser.

Also, if an abbreviation or a unit is an ambiguous word having two or more different meanings, a module that analyzes a context to select an appropriate meaning may select and read a word appropriate for the context.

However, if a text is parsed to acquire a unit or an abbreviation, it may be difficult to select an appropriate full name and to output a voice. An appropriate full name is needed to be searched using a context analysis to identify the best full name.

According to a method of providing a service for reading a webpage as voice information, information, such as a unit, an abbreviation, a table, a picture, or the like, may be analyzed to determine the full name of the information that is appropriate for the situation.

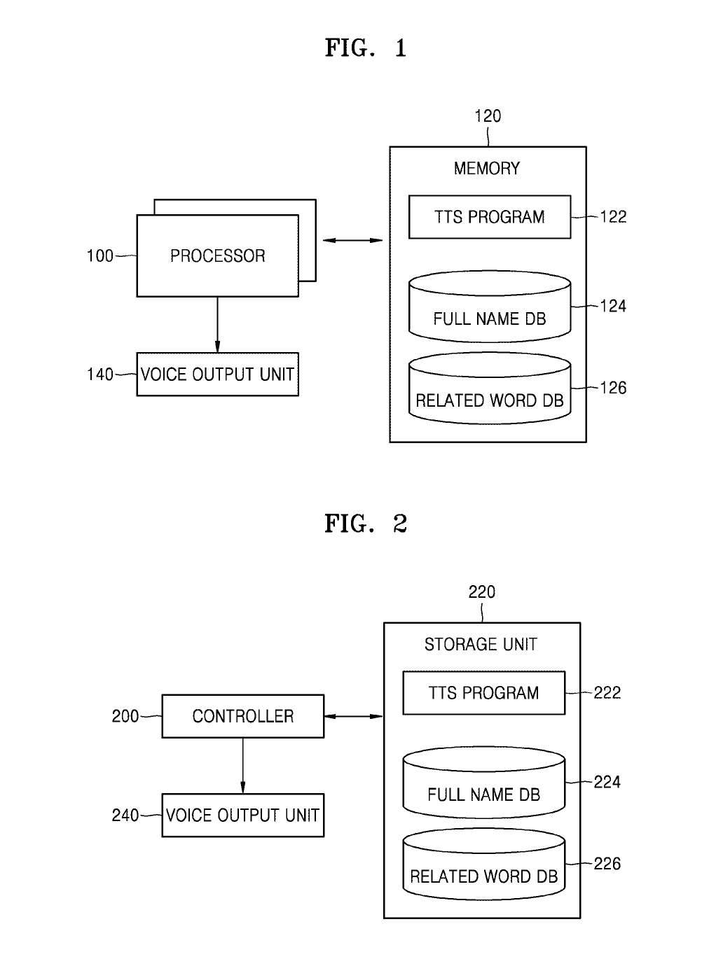

FIG. 1 is a block diagram of an apparatus for outputting a full name voice of a unit or an abbreviation according to an embodiment of the present disclosure.

Referring to FIG. 1, the apparatus includes one or more processors 100, a memory 120, and a voice output unit 140.

The memory 120 stores a text-to-speech (TTS) program 122 and a full name database (DB) 124. A related word DB 126 may be further stored in the memory 120. A unit or an abbreviation includes a corresponding full name (or an original name) in the full name DB 124 that defines the unit or abbreviation.

The voice output unit 140 outputs an execution result of the TTS program 122 as a voice via the voice output unit 140.

The TTS program 122 is configured to be executed by the one or more processors 100, and includes a command for detecting a unit or an abbreviation from a text to be output as a voice, a command for searching the full name DB 124 for the detected unit or abbreviation to acquire a full name corresponding to the detected unit or abbreviation, and a command for converting the acquired full name of the unit or abbreviation into a voice data and outputting a voice.

The command for detecting the unit or abbreviation may further include a command for parsing text information in the unit of a character string having a meaning and a command for detecting the parsed character string when the parsed character string includes an arrangement pattern of a preset number, an alphabet, a symbol, a period, and capital and small letters. If the parsed character string belongs to one selected from “number+alphabet”, “number+non-alphabetic symbol”, “non-alphabetic symbol+number”, “/ between capital or small letters”, “combination of capital letters”, “capital letter+small letter+period”, and “capital letter+period+capital letter+period”, the character string is determined as a unit or an abbreviation.

As another example, even if there is “symbol+number+alphabet”, the character string is regarded as a unit or an abbreviation. Beside this, many more examples of abbreviations and units may occur.

The commands for parsing the character string may include a command for extracting at least a portion of a hypertext mark-up language (HTML) page, a command for extracting only text information by using an extensible mark-up language (XML) analyzer or a regular expression, and a command for parsing the extracted text information into the character string having the meaning.

If two or more full names are searched according to the search result of the full name DB 124, the commands may further include a command for selecting one from the searched full names based on a context of the character string.

The command for selecting one from the searched full names may include a command for extracting keywords from the context, a command for searching a related word DB, and a command for selecting a unit or an abbreviation having a meaning appropriate for the context by using the extracted keywords and the search result of the related word DB.

A search word and words used with the search word are arranged in a table in the related word DB 126 that characterizes the frequency of use of various words used in combination with the abbreviation or unit.

FIG. 2 is a block diagram of an apparatus for outputting a full name voice of a unit or an abbreviation according to an embodiment of the present disclosure.

Referring to FIG. 2, the apparatus includes one or more controllers 200, a storage unit 220, and a voice output unit 240. The storage unit 220 stores a TTS program 222 and a full name DB 224 that stores units or abbreviations corresponding to full names (or an original name) of the units or the abbreviations. The storage unit 220 may store a related word DB 226. The related word DB 226 is a DB that arranges a search word and words used with the search word in frequency orders.

The controller 200 executes the TTS program 222, which causes the controller 200 to detect a unit or an abbreviation from a text, search the full name DB 224 for the detected unit or abbreviation to acquire a full name of the detected unit or abbreviation, and convert the acquired full name corresponding to the unit or abbreviation into a voice data.

The controller 200 may execute the TTS program 222 to parse the text to generate a character string having a meaning and detect if the parsed character string includes a unit or an abbreviation based on if the parsed character string includes a preset number, an alphabet, a symbol, a period, and capital and small letters.

If the parsed character string belongs to one selected from “number+alphabet”, “number+non-alphabetic symbol”, “non-alphabetic symbol+number”, “/ between capital or small letters”, “combination of capital letters”, “capital letter+small letter+period”, and “capital letter+period+capital letter+period”, the character string is determined as a unit or an abbreviation.

As another example, even if there is “symbol+number+alphabet”, the character string is regarded as a unit or an abbreviation. Beside this, many more examples of units or abbreviations may occur.

Also, if two or more full names are searched according to the search result of the full name DB 224, the controller 200 selects one from the searched full names based on a context of the words proximate to the unit or abbreviation.

The controller 200 extracts keywords from the context, searches the related word DB 226 based on the extracted keywords, and selects one from the searched full names based on the search result of the related word DB 226. The voice output unit 240 outputs a full name converted into a voice data as a voice.

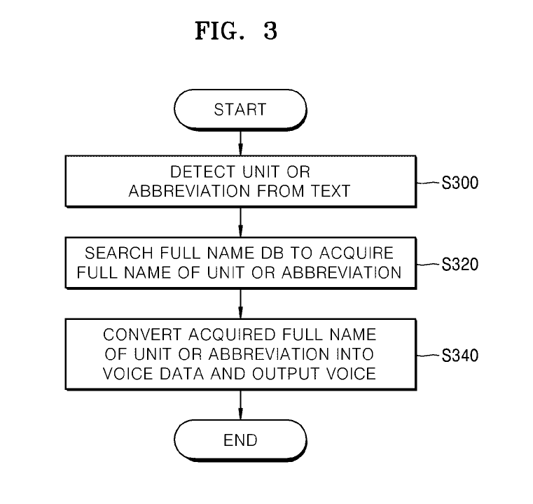

FIG. 3 is a flowchart of a method for outputting a full name voice of a unit or an abbreviation according to an embodiment of the present disclosure.

Referring to FIG. 3, in operation S300, a unit or an abbreviation is detected from a text. In operation S320, the detected unit or abbreviation is searched for in the full name DB to acquire a full name corresponding to the detected unit or abbreviation. In operation S340, the acquired full name corresponding to the unit or abbreviation is converted into a voice data and then output as a voice.

A text is parsed into a character string having a meaning, and the parsed character string is determined to include the unit or abbreviation when the parsed character string includes an arrangement pattern of a preset number, an alphabet, a symbol, a period, and capital and small letters. If the parsed character string belongs to one selected from “number+alphabet”, “number+non-alphabetic symbol”, “non-alphabetic symbol+number”, “/ between capital or small letters”, “combination of capital letters”, “capital letter+small letter+period”, and “capital letter+period+capital letter+period”, the character string is determined as including the unit or abbreviation.

As another example, even if there is “symbol+number+alphabet”, the character string is regarded as a unit or an abbreviation. Beside this, many more examples may occur.

Also, an HTML page is acquired, a text is extracted from the acquired HTML page by using an XML analyzer or a regular expression, and the extracted text is parsed into the character string having the meaning.

If two or more full names are searched according to the search result of the full name DB, one is selected based on a context. Here, keywords may be extracted from a context of the unit or abbreviation, and a related word DB may be searched to select one from the searched full names based on the context by using the extracted keywords and the search result of the related word DB.

Here, the related word DB that characterizes the frequency of use of various words used in combination with the abbreviation or unit.

Also, if the unit or abbreviation is converted into a full name, the full name may be converted into a voice data to be output as a voice. In addition, if the unit or abbreviation is converted into a full name, the full name may not be converted into a voice data. If the number of words to be converted into voice data exceeds a preset number, the preset number of words may be converted into voice data.

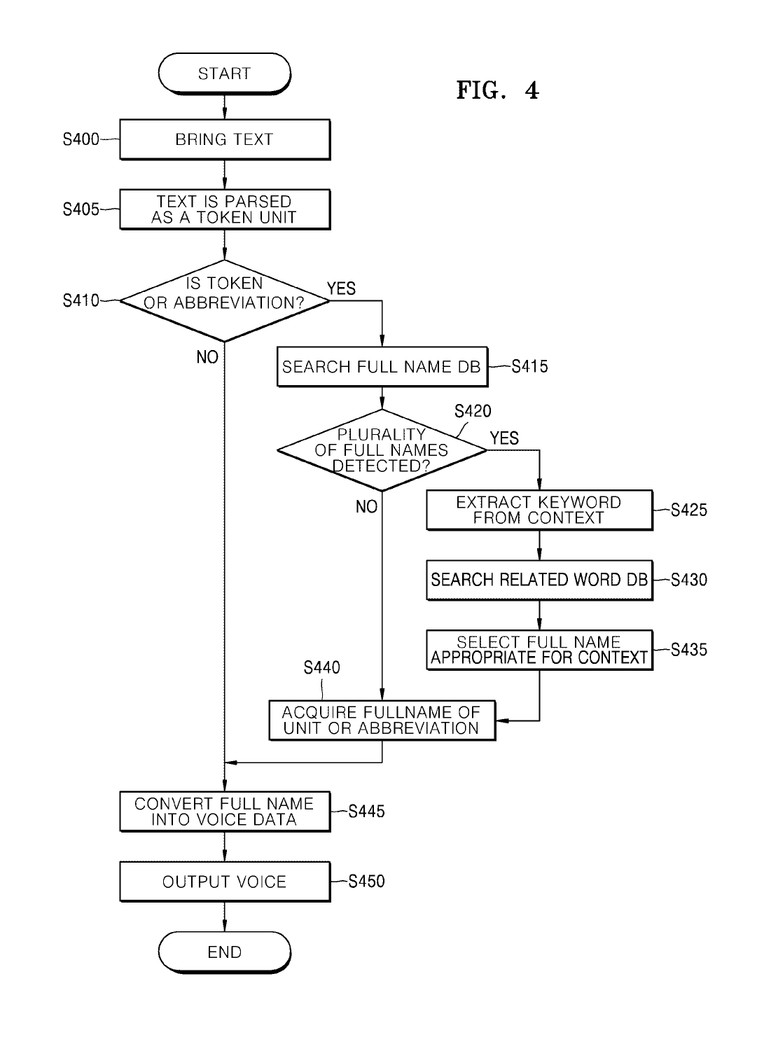

FIG. 4 is a flowchart of a method for outputting a full name voice of a unit or an abbreviation according to an embodiment of the present disclosure.

A unit, an abbreviation, or the like of text information from a webpage is converted into a full name. The webpage is described in the present embodiment but is not limited thereto. Therefore, the present embodiment may be applied to texts of a mobile device, a television (TV), home appliances, a navigation system, etc.

Hereinafter, a method of outputting a unit or an abbreviation existing on a webpage as a voice will be described.

Referring to FIG. 4, in operation S400, text information is extracted from a webpage. That is, text information may be parsed and extracted from the HTML of the webpage by using an XML parser or a regular expression.

If the text is extracted, the text is parsed as a token unit into a character string unit having a meaning in operation S405. Here, the parsing refers to a process of parsing a series of character strings as meaningful tokens and forming a parse tree including the meaningful tokens.

In operation S410, it is determined whether any of the tokens include a unit or an abbreviation. It is important to accurately detect a unit or an abbreviation from the text extracted from the webpage. The following descriptions further describe various embodiments of the present disclosure, but the instant disclosure is not limited to these examples.

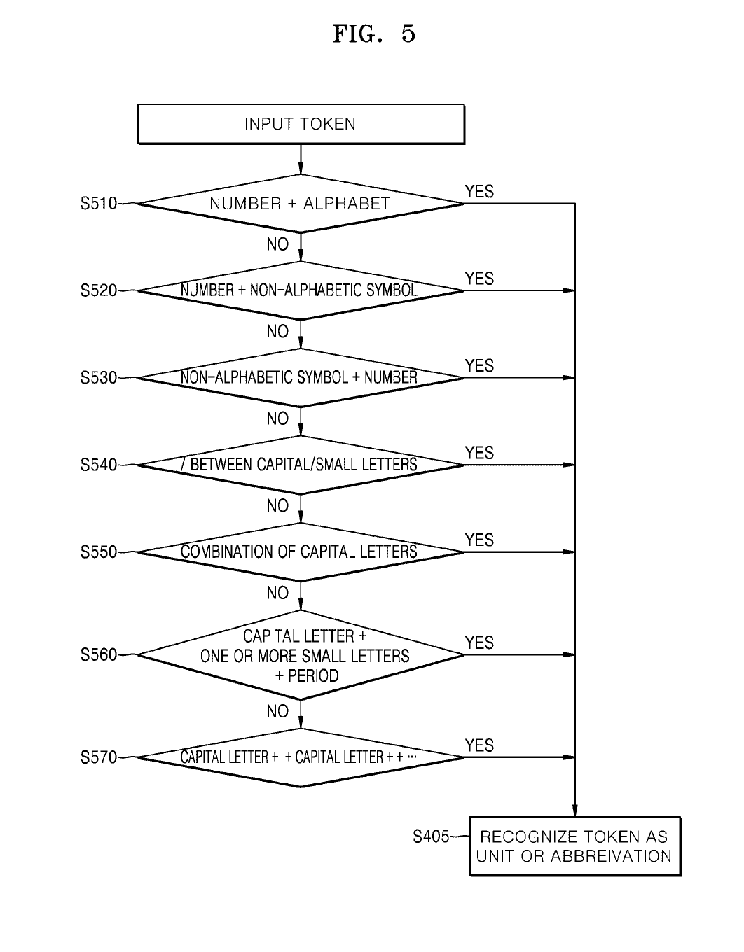

FIG. 5 is a flowchart of a method for detecting a unit or an abbreviation according to an embodiment of the present disclosure.

Referring to FIG. 5, if a token is input and includes “number+alphabet”, e.g., is 10 m, 10 Kg, 10 mm, or the like, the token is recognized as a unit in operation S510. If the token includes “number+non-alphabetic symbol”, e.g., 10° C., the token is recognized as the unit in operation S520.

If the token includes “non-alphabetic symbol+number”, e.g., is NW10 or the like, the token is recognized as the unit in operation S530. If the token includes “/” between capital and small letters, e.g., is N/c, m/s, or the like, the token is recognized as a unit or an abbreviation in operation S540.

If the token is formed of a combination of capital letters, e.g., is CPA or the like, the token is recognized as an abbreviation in operation S550. If the token includes “capital letter+small letter+period” (e.g., Dr. or the like), the unit is recognized as an abbreviation in operation S560.

If the token includes “capital letter+period+capital letter+period”, e.g., U.S.A. or the like, the token is recognized as an abbreviation in operation S570.

If tokens are classified according to categories, and the categories are respectively accessed according to corresponding cases as described above, a search time may be reduced.

Referring back to FIG. 4, if a unit or an abbreviation is detected through the above-described process, the full name DB is searched in operation S415 based on the unit. If a word corresponding to a unit or an abbreviation is identified from searching the full name DB, a text associated with the unit or abbreviation matches with the word.

In operation S420, a determination is made as to whether a plurality of full names are detected (i.e., the unit or abbreviation is ambiguous because the unit or abbreviation is associated with multiple text descriptions) according to the search result. If only a single full name is detected in operation S420, the method proceeds to operation S440.

If a plurality of full names is detected in operation S420, a keyword is extracted from a context of the text in operation S425. In operation S430, a related word DB is searched based on the context. In operation S435, the full name is selected based on the extracted keyword and the search result of the related word DB. In other words, if a full name DB includes two or more meanings, a keyword is extracted from a context in operation S425 to be determined as a criterion for selecting an appropriate meaning. According to a method of detecting a keyword from a context, a related DB includes a search word and words used with the search word and then matches with a sentence of a paragraph or a whole webpage to extract keywords based on an order of probabilities.

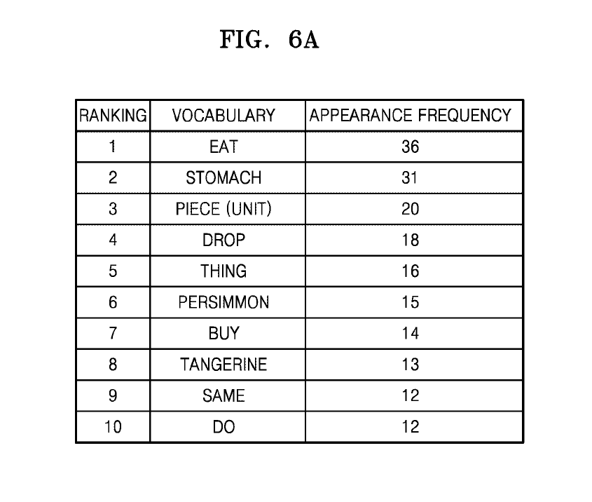

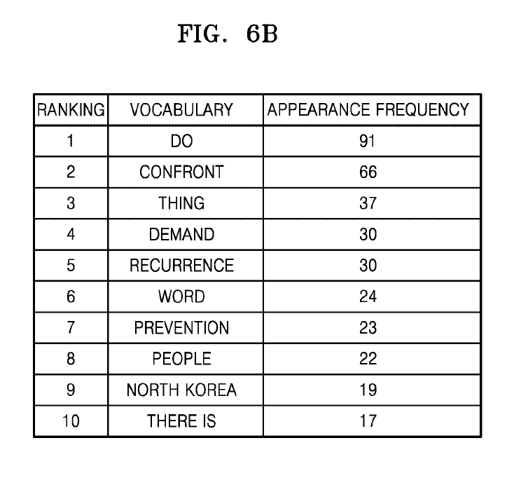

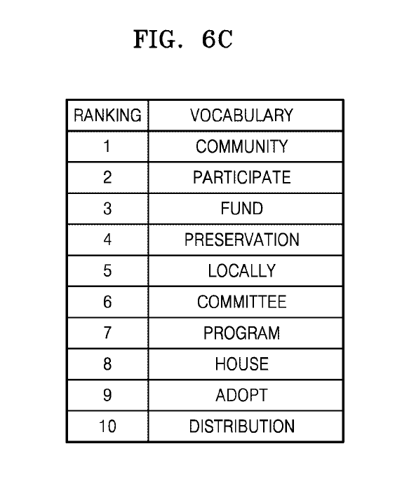

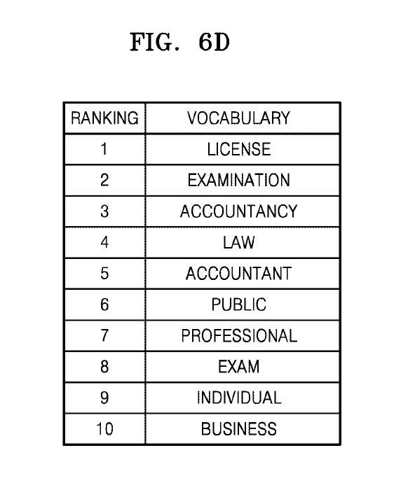

For example, if the unit or abbreviation is “cm”, a number frequently appears in a front part with a word such as a length, a width, a height, a breadth, or the like indicating a length. Also, there is a rule where a length is written with a small letter. Therefore, “cm” may be easily distinguished from “CM song”, “Construction Management”, or the like. Even in case of “CM”, related words are searched based on an order of words appearing before and after the context in operation S430 to accurately search for an original meaning thereof in operation S435. Here, an example of constituting a related word DB may be illustrated in FIGS. 6A to 6D.

FIGS. 6A to 6D are views illustrating correlations between vocabularies appearing in meanings of the vocabularies and surrounding contexts according to various embodiments of the present disclosure.

Referring to FIGS. 6A to 6D, a word “apple” may have different related words according to different meanings thereof, and thus an appropriate meaning may be selected based on an order of search words frequently detected from a context. Here, a method of extracting in units of a noun or a verb for a fast search to search for a meaning based on the extracted noun or verb may be selected. Various types of related algorithms may be used to solve an ambiguity of a vocabulary.

Referring back to FIG. 4, in operation S440, a full name of a unit or an abbreviation is acquired by using an appropriate meaning selected through the above-described process. In other words, if the search word is not the ambiguous word in operation S420 or the full name appropriate for the context is selected in operation S435, the full name of the unit or the abbreviation is acquired in operation S440.

In operation S445, the full name of the unit or the abbreviation is converted into voice data. In operation S450, the voice data is output as a voice. In other words, the full name is acquired, the full name is converted into the voice data in operation S445, and a voice is output in operation S450.

Here, several voice converting methods may occur. The first voice converting method converts all converted sentences into voice data at one time. This method may cause a synthesis speed to slow if a sentence is very long.

The second voice converting method converts the tokens into voice data through a flowchart. This method is favorable even if a sentence is long because an abbreviation full naming module and a synthesis of sentences converted into voices are processed in parallel. Besides this, the method also includes all of processes, etc. that may occur when performing a voice conversion.

According to a method and an apparatus for outputting a full name voice of a unit or an abbreviation, a text may be directly parsed on a webpage instead of an optical character recognition to reduce a misrecognition rate and improve a processing speed.

Also, a version of a DB server specialized for a mobile may be used for a full name DB to improve performance.

Herein, a context may be parsed to determine an appropriate full name of a corresponding unit or abbreviation. Therefore, an ambiguous word including two or more meanings of the detected unit or abbreviation may also be processed.

According to the present disclosure, a service for reading a text from a webpage, converting the text into a technical term appropriate for a context such as a unit, an abbreviation, or the like, and converting the technical term into a voice may be provided. Therefore, a convenience of a user may be provided. A context of a text content of the webpage may be parsed to be converted into an appropriate term.

This may assist a general user and a visually handicapped person who has a low accessibility to a webpage.

According to the present disclosure, a webpage and a mobile terminal may also provide a smart talkback service for an accessibility of the visually handicapped person. As a result, a webpage reader may provide a further intuitive interface to the user so as to improve a service convenience of the user.

In general, misrecognition may occur due to optical character recognition. Therefore, there is a need for a method of acquiring a text by using another method. According to the present disclosure, a function of reading a unit, an abbreviation, or the like as an appropriate word may be a useful to an ordinary person who is engaged in an activity (e.g., driving, cooking, etc.) and may not be able to readily perceive the content.

The present disclosure may also be embodied as computer readable codes on a computer-readable recording medium. The computer-readable recording medium is any data storage device that may store programs or data which may be thereafter read by a computer system. Examples of the computer-readable recording medium include read-only memory (ROM), random-access memory (RAM), compact disc ROMs (CD-ROMs), magnetic tapes, hard disks, floppy disks, flash memory, optical data storage devices, and so on.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of outputting a full name voice of a unit or an abbreviation, the method comprising:
detecting a unit or an abbreviation from text to be output as a voice;
searching a full name database (DB) for the detected unit or abbreviation and acquiring a full name corresponding to the detected unit or abbreviation; and
converting the acquired full name corresponding to the detected unit or abbreviation into a voice data and outputting a voice.

2. The method of claim 1, wherein the detecting of the unit or the abbreviation comprises:
parsing the text into a character string having a meaning; and
when the parsed character string is a preset arrangement pattern including at least one of a number, an alphabet, a symbol, a period, and capital and small letters, determining the parsed character string as the unit or the abbreviation.

3. The method of claim 2, wherein, if the character string is one of a “number+alphabet”, “number+non-alphabetic symbol”, “non-alphabetic symbol+number”, “/ between capital letters or small letters”, “combination of capital letters”, “capital letter+small letter+period”, “capital letter+period+capital letter+period”, and “symbol+number+alphabet”, determining that the character string is the unit or the abbreviation.

4. The method of claim 2, wherein the parsing of the text further comprises:
acquiring a hypertext mark-up language (HTML) page;
extracting only text from the acquired HTML page by using an extensible mark-up language (XML) parser or a regular expression; and
parsing the extracted text in into the character string having the meaning.

5. The method of claim 1, further comprising:
if two full names are found in the search result of the full name DB, selecting one of the two found full names based on a context of the detected unit or abbreviation.

6. The method of claim 5,
wherein the selecting of the one of the two found full names comprises:
extracting keywords from the context;
searching a related word DB; and
selecting one of two or more full names based on the extracted keywords in view of the context and based on the search, and
wherein the related word DB is configured to rank search words and words used with the search word according to frequency of use.

7. The method of claim 1, wherein the outputting of the voice comprises:
if the full name corresponding to the detected unit or abbreviation is acquired, converting the acquired full name into a voice data and outputting a voice.

8. The method of claim 1, wherein the outputting of the voice comprises:
if the full name corresponding to the detected unit or abbreviation is acquired, counting the number of words to be converted into voice data, and
if the number of words is greater than or equal to a preset number, converting the acquired full name into a voice data and outputting a voice.

9. An apparatus for outputting a full name voice of a unit or an abbreviation, the apparatus comprising:
a processor configured to execute one or more programs;
a memory configured to store a text-to-speech (TTS) program and a full name database (DB); and
an audio output device configured to output an execution result of the TTS program as a voice,
wherein the TTS program comprises:
a command for detecting a unit or an abbreviation from a text to be output as a voice,
a command for searching the full name DB for the detected unit or abbreviation to acquire a full name corresponding to the detected unit or abbreviation, and
a command for converting the acquired full name corresponding to the unit or abbreviation into a voice data and outputting a voice.

10. The apparatus of claim 9, wherein the command for detecting the unit or the abbreviation comprises:
a command configured to parse the text into a character string having a meaning; and
a command configured to, when the parsed character string is formed in an arrangement pattern of a preset number, an alphabet, a symbol, a period, and capital and small letters, detect the parsed string as the unit or the abbreviation.

11. The apparatus of claim 10, wherein, if the parsed character string having the meaning is one selected from “number+alphabet”, “number+non-alphabetic symbol”, “non-alphabetic symbol+number”, “/ between capital letters or small letters”, “combination of capital letters”, “capital letter+small letter+period”, “capital letter+period+capital letter+period”, and “symbol+number+alphabet”, the character string is detected as the unit or the abbreviation.

12. The apparatus of claim 10, wherein the command configured to parse the text information comprises:
a command configured to bring a hypertext mark-up language (HTML) page from a webpage;
a command configured to extract only text by using an extensible mark-up language (XML) parser or a result expression; and
a command configured to parse the extracted text into the character string having the meaning.

13. The apparatus of claim 9, further comprising:
a command configured to, if two full names are found in the search of the full name DB, select one of the two found full names based on a context of the detected unit or abbreviation.

14. The apparatus of claim 13,
wherein the command configured to select the one of the two found full names comprises:
a command configured to extract keywords from the context;
a command configured to search a related word DB; and
a command configured to select a unit or an abbreviation having a meaning appropriate for a context by using the extracted keywords and the search result of the related word DB, and
wherein the related word DB is a DB configured to rank search words and words used with the search word according to frequency of use.

15. An apparatus for outputting a full name voice of a unit or an abbreviation, the apparatus comprising:
a storage unit configured to store a text-to-speech (TTS) program and full name database (DB);
a controller configured to execute the TTS program to cause the controller to:
detect a unit or an abbreviation from a text to be output as a voice,
search the full name DB for the detected unit or abbreviation,
acquire a full name of the detected unit or abbreviation, and
convert the acquired full name corresponding to the unit or abbreviation into a voice data; and
an audio output device configured to output the full name converted into the voice data as a voice.

16. The apparatus of claim 15, wherein the TTS program further causes the controller to:
parse text information into a character string having a meaning, and
when the parsed character string is a preset arrangement pattern including at least one of a number, an alphabet, a symbol, a period, and capital and small letters, determine that the parsed character string is the unit or the abbreviation.

17. The apparatus of claim 16, wherein, if the parsed character string having the meaning is one of “number+alphabet”, “number+non-alphabetic symbol”, “non-alphabetic symbol+number”, “/ between capital letters or small letters”, “combination of capital letters”, “capital letter+small letter+period”, “capital letter+period+capital letter+period”, and “symbol+number+alphabet”, the TTS program further causes the controller to determine that the character string is the unit or the abbreviation.

18. The apparatus of claim 15, wherein, if two or more full names are found based on the search of the full name DB, the TTS program further causes the controller to select one of the two or more full names based on a context.

19. The apparatus of claim 18,
wherein the storage unit is further configured to store a related word DB configured to rank search words and words used with the search word according to frequency of use, and
wherein the TTS program further causes the controller to:
extract keywords from the context,
search the related word DB, and
select one of the searched full names based on the context by using the extracted keywords and the search result of the related word DB.

20. A non-transitory computer-readable recording medium having recorded thereon a computer program for executing the method of claim 1.
